(19) United States
(12) Patent Application Publication
(10) Pub. No.: US 2009/0266654 A1
(43) Pub. Date: Oct. 29, 2009

(54) ELASTOMERIC STABILIZERS FOR BRAKE CALIPER ASSEMBLY ON UTILITY VEHICLE

(76) Inventor: Ronald Paul Holland, Fox Lake, WI (US)

Correspondence Address: DEERE & COMPANY, ONE JOHN DEERE PLACE, MOLINE, IL, 61265, US

(21) Appl. No.: 12/109,865

(22) Filed: Apr. 25, 2008

(51) Int. Cl. F16D 65/18

(52) U.S. Cl. 188/73.31

(57) ABSTRACT

A brake caliper assembly on a utility vehicle includes a brake caliper arm pivotably mounted to a stationary actuator, and a pair of brake pads on each side of a disc coupled to a driven shaft of the utility vehicle. One of the brake pads has a pair of holes with a mounting sleeve inserted through each hole. The brake pads are moveable with respect to the mounting sleeve in response to pivotal movement of the brake caliper arm to urge the brake pads into contact with the disc. Elastomeric stabilizers are positioned in the brake pad holes around each mounting sleeve.

### FIELD OF THE INVENTION

This invention relates generally to brakes for off-road utility vehicles, and more specifically to a disc brake caliper assembly for such vehicles.

### BACKGROUND OF THE INVENTION

Off-road utility vehicles, golf carts, and zero turn mowers may be equipped with a disc brake caliper assembly that may be hand operated to apply braking force to the drive train or wheel. For example, U.S. Pat. No. 7,040,462 entitled “Ball Ramp Caliper Brake” illustrates a caliper disc brake having several metal balls positioned in ramped depressions between a pivoting caliper arm and a stationary actuator. The brake may be applied by pulling a hand lever or actuating a pedal with a linkage or cable attached to the caliper arm. As the caliper arm pivots, the balls are urged out of the depressions, forcing the caliper arm away from the actuator, and moving friction material on inner and outer brake pads against opposing sides of a brake disc or rotor.

The stationary actuator may be mounted to a bracket on the vehicle frame or transmission with a pair of mounting sleeves and mounting bolts. The mounting sleeves are slidably received through holes in the actuator, and through the inner and outer brake pads. The mounting bolts are inserted through the mounting sleeves and threaded onto nuts fastening the mounting bolts to a bracket on the vehicle frame or transmission.

Additionally, the spacing between the inner and outer brake pads may be set with a pair of bridge sleeves, bridge bolts, and bridge springs. The bridge sleeves are slidably received through holes in the inner and outer brake pads. Each bridge bolt may be inserted through a bridge sleeve and a hole in the actuator, and fastened with a nut to the inner brake pad. A bridge spring around each bridge sleeve biases the inner and outer brake pads apart, and helps maintain the balls in the depressions.

The inner and outer brake pads may float on the sleeves to allow for slight axial misalignment and lateral motion with respect to the disc or rotor. However, at times the floating pads may contact or rub against the disc or rotor, causing wear of the disc or rotor, and wear of the friction material used in the brake pads. The wear may result in noise, vibration and harsh operation of the brake caliper assembly. The wear also may result in the need for adjustment or replacement of the brake pads. Even if the brake pads do not contact the disc or rotor, they may vibrate against the mounting sleeves or other parts to create noise.

A brake caliper assembly for a utility vehicle is needed having a longer life and reduced frequency of adjustment. A stabilizer for a brake caliper assembly on a utility vehicle is needed to reduce wear of the disc or rotor, and reduce wear to the friction material on the brake pads. A stabilizer for a brake caliper assembly on a utility vehicle is needed that reduces or eliminates noise, vibration and harshness of operation. A brake caliper assembly for a utility vehicle is needed having improved stability.

### SUMMARY OF THE INVENTION

Elastomeric stabilizers are provided for a brake caliper assembly on a utility vehicle. The brake caliper assembly includes a pair of brake pads moveable toward a disc coupled to the driveline upon actuation of a parking brake lever or pedal. A pair of springs urge the pair of brake pads away from the disc and maintain adequate spacing from the disc. A pair of mounting bolts extend through holes in the pair of brake pads, with a first end attached to a stationary actuator and a second end attached to a mounting bracket. The elastomeric stabilizers are positioned between each of the mounting bolts and at least one of the brake pads.

The elastomeric stabilizers help increase the life of the brake pads, and reduces frequency of adjustment. The elastomeric stabilizers reduce wear of the disc or rotor, and also reduce wear to the friction material on the brake pads. The elastomeric stabilizers reduce or eliminate noise, vibration and harshness of operation, and improve stability of the brake caliper assembly.

### BRIEF DESCRIPTION OF THE DRAWINGS

FIG. 1 is a perspective view of a brake caliper assembly with elastomeric stabilizers on a utility vehicle according to a first embodiment of the invention.

FIG. 2 is a side view of a brake caliper assembly with elastomeric stabilizers on a utility vehicle according to a first embodiment of the invention.

FIG. 3 is an exploded perspective view of a brake caliper assembly with elastomeric stabilizers for a utility vehicle according to a first embodiment of the invention.

### DESCRIPTION OF THE PREFERRED EMBODIMENT

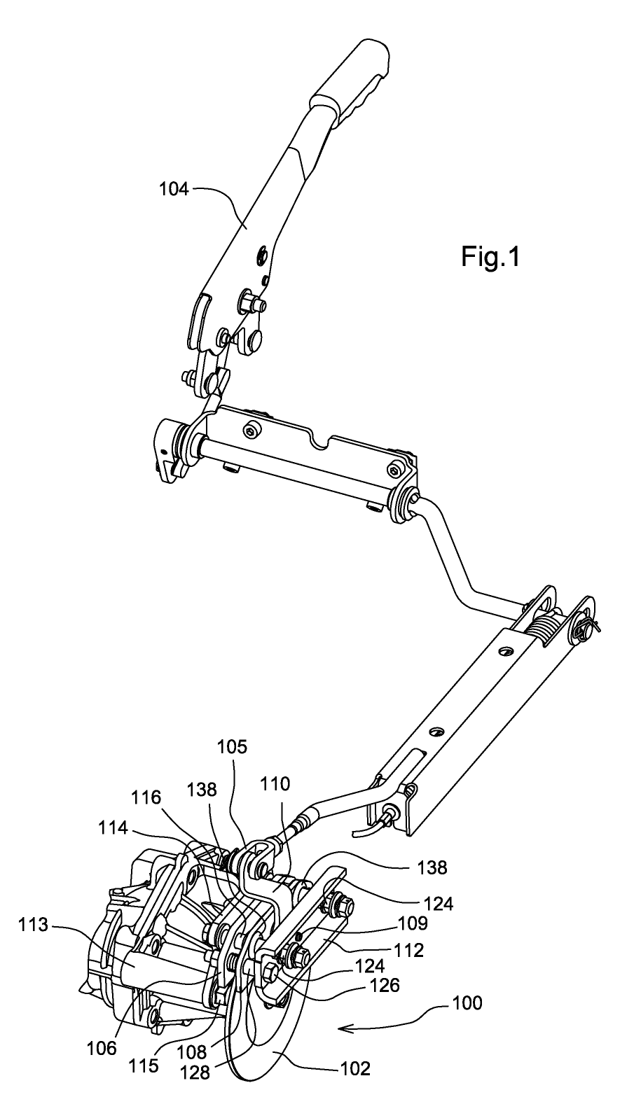

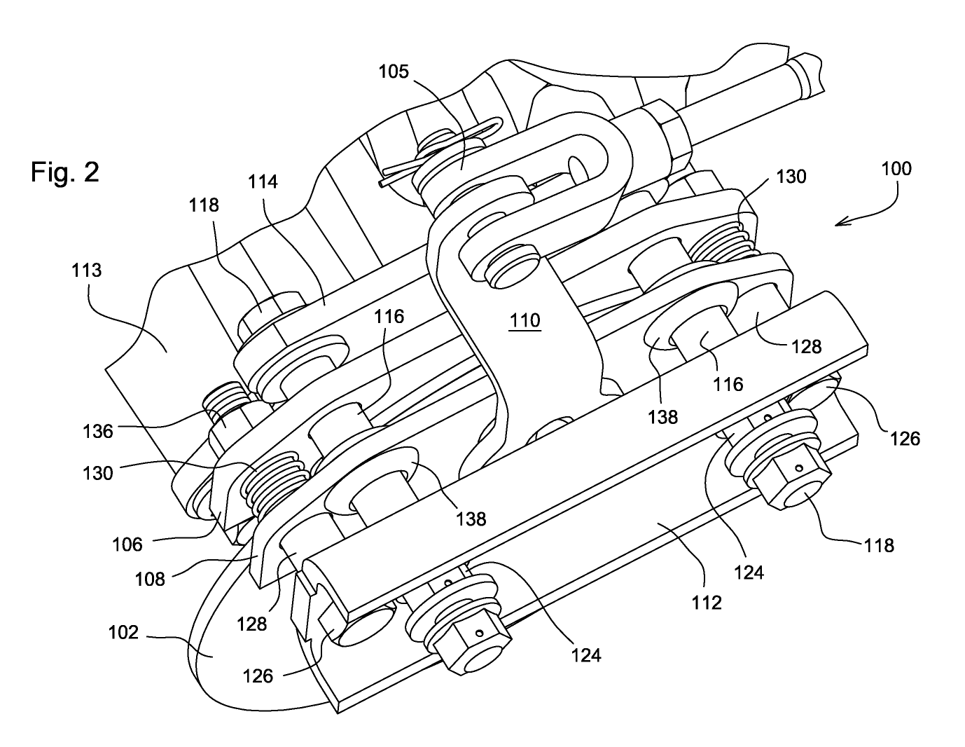

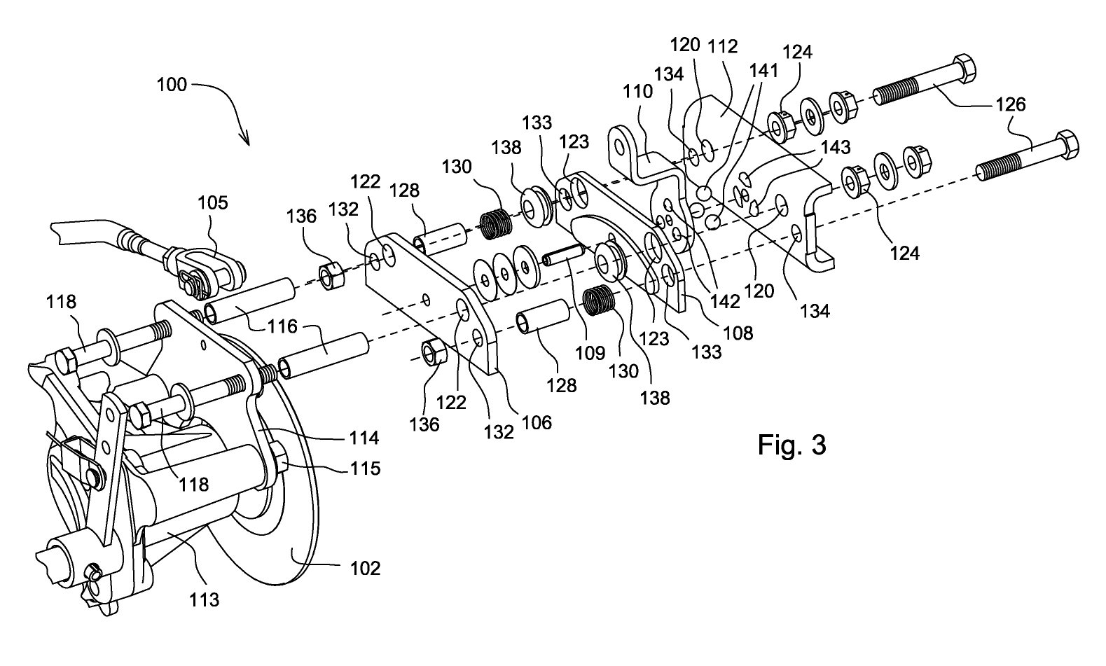

In a first embodiment shown in FIGS. 1-3, brake caliper assembly 100 is positioned adjacent disc or rotor 102 which is coupled to a driveline or shaft on a utility vehicle transmission. Alternatively, the disc or rotor may be coupled to a wheel axle of a utility vehicle. The brake caliper assembly may be actuated by hand lever 104 or a foot pedal connected by linkage 105 to caliper arm 110. Pulling on the hand lever or actuating the foot pedal may cause the inner brake pad 106 and outer brake pad 108, located on opposite sides of the disc or rotor, to move closer together and apply pressure to the disc or rotor. The surface of each brake pad is provided with friction material.

In one embodiment, the first end of caliper arm 110 is connected to linkage 105, and the second end of the caliper arm is pivotably connected to stationary actuator 112. The second end of the caliper arm may be pivotably connected to the stationary actuator at a position between the stationary actuator and outer brake pad 108. The pivotal connection may be spring pin 109 or similar device providing a pivotal axis between the caliper arm and the stationary actuator.

In one embodiment, bracket 114 is mounted onto transmission housing 113 with a plurality of bolts 115. Stationary actuator 112 is mounted to bracket 114 with a pair of mounting sleeves 116 and mounting bolts 118. The two mounting sleeves are slidably received through holes 120 in the stationary actuator, and through two holes 122, 123 in the inner and outer brake pads 106, 108. The mounting bolts are inserted through the sleeves and threaded onto nuts 124 fastening the mounting bolts to the bracket on the vehicle frame or transmission. The mounting bolts and sleeves allow relative movement of the inner and outer brake pads.

In one embodiment, a pair of bridge bolts 126, bridge sleeves 128 and bridge springs 130 help provide the necessary spacing between the inner and outer brake pads 106, 108 when the brake assembly is not actuated. The springs also help provide adequate clearance between each of the brake pads and the rotor or disc. The two bridge sleeves are slidably received through two holes 132, 133 in the inner and outer brake pads. Each bridge bolt may be inserted through a bridge sleeve and a hole 134 in the actuator, and fastened with a nut 136 to the inner brake pad. The bridge spring on each bridge sleeve not only biases the inner and outer brake pads apart, but also helps hold metal balls 141 in concave depressions 142, 143 until the brake is actuated by the operator.

In one embodiment, the second end of caliper arm 110 and stationary actuator 112 each include a plurality of concave depressions 142, 143. A metal ball 141 is positioned between each depression 142 in the caliper arm and corresponding depression 143 in the stationary actuator. In the non-actuated state, the depressions are axially aligned and the metal balls are positioned in the center of each depression. When the brake is actuated by pivoting the caliper arm, the depressions in the caliper arm move out of alignment with the corresponding depressions in the actuator. This forces the balls to ride up on the depressions, pushing the caliper arm away from the stationary actuator, and forcing the outer brake pad away from the caliper arm and toward the disc or rotor. This also forces the inner brake pad against the disc or rotor. The brake caliper assembly is free to slide axially along the mounting sleeves, so the pressure applied by the inner and outer brake pads against the disc or rotor will be substantially the same.

In one embodiment, elastomeric stabilizers 138 are provided between each mounting sleeve and at least one of the brake pads. The elastomeric stabilizers may be positioned between outer diameter of mounting sleeve 116 and the holes 123 in the outer brake pad. For example, the elastomeric stabilizers may be rubber grommets having an interference but moveable relationship with the mounting sleeves and the holes through the outer brake pad. During assembly, the rubber grommets may be positioned in the brake pad holes before inserting the mounting sleeves and mounting bolts through the rubber grommets. The rubber grommets, or other elastomeric stabilizing components, dampen movement of the outer brake pad.

In one embodiment, elastomeric stabilizers 138 may stabilize the brake caliper assembly by resisting or dampening axial motion of outer brake pad 108 with respect to sleeve 116 and stationary actuator 112. Additionally, the elastomeric stabilizing components stabilize the brake caliper assembly by helping maintain the appropriate clearance between the inner brake pad 106 and disc or rotor 102. As a result, the elastomeric stabilizers reduce friction material wear, rotor or disc wear, vibration or noise. The elastomeric stabilizers also reduce wear of the linkage supporting bushings and joints.

Having described a preferred embodiment, it will become apparent that various modifications can be made without departing from the scope of the invention as defined in the accompanying claims.

1. A brake caliper assembly on a utility vehicle, comprising:
a brake caliper arm pivotably mounted to a stationary actuator;
a pair of brake pads, one brake pad on each side of a disc coupled to a driven shaft of the utility vehicle;
each of the brake pads having a pair of holes with a mounting sleeve inserted through each hole; the brake pads being moveable with respect to the mounting sleeve in response to pivotal movement of the brake caliper arm to urge the brake pads into contact with the disc; and
an elastomeric stabilizer positioned in at least one of the brake pad holes around the mounting sleeve.

2. The brake caliper assembly of claim 1 wherein the elastomeric stabilizer is a rubber grommet.

3. The brake caliper assembly of claim 1 wherein the disc is coupled to a driveline on a transmission of the utility vehicle.

4. The brake caliper assembly of claim 1 further comprising a plurality of metal balls between the stationary actuator and the brake caliper arm.

5. A brake caliper assembly on a utility vehicle, comprising:
an inner brake pad and an outer brake pad mounted on opposing sides of a rotor;
a spring urging the inner and outer brake pads apart;
a brake actuator connected to an operator actuatable linkage to urge the brake pads closer together;
a pair of with mounting sleeves slidably received through the brake pads; and
an elastomeric stabilizer around each of the mounting sleeves and extending through at least one of the inner brake pad and the outer brake pad.

6. The brake caliper assembly of claim 5 wherein the brake actuator is pivotable to urge the inner brake pad an outer brake pad closer together.

7. The brake caliper assembly of claim 6 further comprising a plurality of metal balls positioned in concave depressions in the brake actuator, the metal balls riding up from the depressions when the brake actuator is pivoted.

8. The brake caliper assembly of claim 5 further comprising a pair of bridge bolts extending between the inner brake pad and outer brake pad; a sleeve around each of the bridge bolts, each of the springs around one of the sleeves.

9. The brake caliper assembly of claim 5 wherein each of the elastomeric stabilizers is a rubber grommet.

10. The brake caliper assembly of claim 5 wherein the rotor is coupled to a driveline of the utility vehicle.

11. A brake caliper assembly on a utility vehicle, comprising:
a disc coupled to a transmission driveline on the utility vehicle;
a pair of brake pads moveable toward the disc upon actuation of a parking brake lever;
a pair of springs urging the pair of brake pads away from the disc to maintain spacing from the disc;
a pair of mounting bolts extending through holes in the pair of brake pads and having a first end attached to a stationary actuator and a second end attached to a mounting bracket; and
an elastomeric stabilizer between each of the mounting bolts and at least one of the brake pads.

12. The brake caliper assembly of claim 11 further comprising a sleeve between each of the mounting bolts and the elastomeric stabilizer.

13. The brake caliper assembly of claim 11 further comprising a pair of bridge bolts extending through each of the springs.

14. The brake caliper assembly of claim 11 further comprising a caliper arm is pivotable in response to actuation of the parking brake lever to move the brake pads toward the disc.

15. The brake caliper assembly of claim 14 further comprising a plurality of balls positioned in depressions in the stationary actuator and the caliper arm, the balls riding up from the depressions upon pivoting of the caliper arm.
